(19) United States
(12) Patent Application Publication
(10) Pub. No.: US 2006/0182033 A1
(43) Pub. Date: Aug. 17, 2006

(54) Fast multicast path switching

(75) Inventors: Shiwen Chen, Marlboro, NJ (US); Harumine Yoshiba, Yokohama (JP)

Correspondence Address: HARNESS, DICKEY & PIERCE, P.L.C., P.O. BOX 828, BLOOMFIELD HILLS, MI, 48303, US

(73) Assignee: Matsushita Electric Industrial Co., Ltd., Osaka (JP)

(21) Appl. No.: 11/058,561

(22) Filed: Feb. 15, 2005

(51) Int. Cl. H04L 12/26; G06F 11/00

(52) U.S. Cl. 370/237; 370/389; 370/225

(57) ABSTRACT

An improved method is provided for switching paths at a network routing device residing in a multicast distribution environment. The method includes: maintaining a plurality of predetermined path sets in a data store associated with the network routing device, where each path set corresponds to a given network condition and defines a path for each data transmission session; receiving a message indicative of a current network condition at the network routing device; selecting a path set from the plurality of predetermined path sets, where the selected path set correlates to the current network condition; and configuring the network routing device in accordance with the selected path set.

### FIELD OF THE INVENTION

The present invention relates generally to multicast routing protocols and, more particularly, to a fast path switching mechanism for use in multicast distribution environments.

### BACKGROUND OF THE INVENTION

Currently, multicast distribution systems use various protocols for multicast routing. Multicast routing protocols are in general distributed, dynamic and unmanaged. Routers need to communicate with each other, under the specification of a certain protocol, to collaborate when forwarding multicast traffic. When a network failure occurs, the time to restore multicast delivery to each multicast member site is relatively long. Certain applications, such as network surveillance systems, are very sensitive to lengthy recovery times from a network failure.

To address these and other concerns, multicast path allocation may be centralized. Rather than allocating paths independently from each other, paths are allocated in an optimal manner with knowledge of all sessions. In addition, path allocations are made assuming certain network failure conditions. This approach ensures that resources are available when such failure conditions occur. Moreover, the predetermined paths enable a fast multicast path switching mechanism which reduces the recover time from a network failure.

### SUMMARY OF THE INVENTION

An improved method is provided for switching paths at a network routing device residing in a multicast distribution environment. The method includes: maintaining a plurality of predetermined path sets in a data store associated with the network routing device, where each path set corresponds to a given network condition and defines a path for each data transmission session; receiving a message indicative of a current network condition at the network routing device; selecting a path set from the plurality of predetermined path sets, where the selected path set correlates to the current network condition; and configuring the network routing device in accordance with the selected path set.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 depicts an exemplary multicast surveillance system;

FIG. 2 is a flowchart illustrating an improved method for path switching in a multicast distribution environment according to the principles of the present invention;

FIG. 3 depicts a plurality of predetermined path sets in accordance with one aspect of the present invention;

FIG. 4 is a flowchart illustrating an exemplary procedure for determining a plurality of path sets; and

FIG. 5 is a flowchart illustrating an exemplary procedure for a control program implemented by the route managing subsystem in accordance with the present invention.

### DETAILED DESCRIPTION OF THE PREFERRED EMBODIMENTS

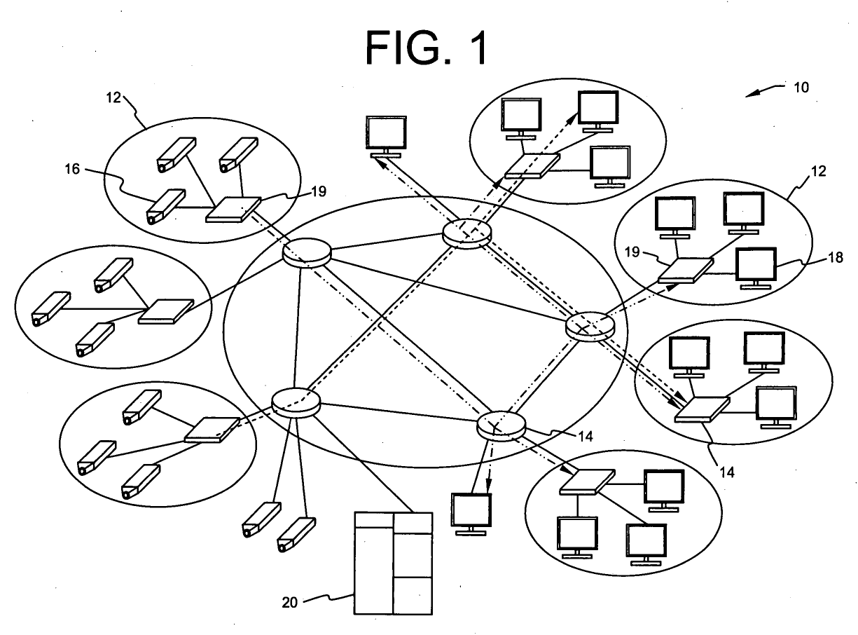

FIG. 1 depicts an exemplary multicast surveillance system 10. The surveillance system 10 is generally comprised of a plurality of cameras 16 and a plurality of monitors 18 interconnected by a network environment. In this exemplary multicast distribution system, the cameras 16 serve as multicast sources and the monitors 18 serve as multicast destinations. The network environment is further defined as a plurality of interconnected network routing devices 14 as is well known in the art. In some instances, a subset of cameras or monitors are grouped at a network site 12 and then connected via an IP switch 19 to the network environment. The surveillance system 10 also includes a path management server 20 as will be further described below. While the following description is provided with reference to a multicast surveillance system, it is readily understood that the broader aspects of the present invention are applicable to other types of multicast distribution systems.

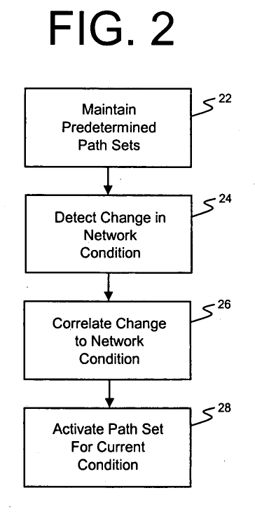

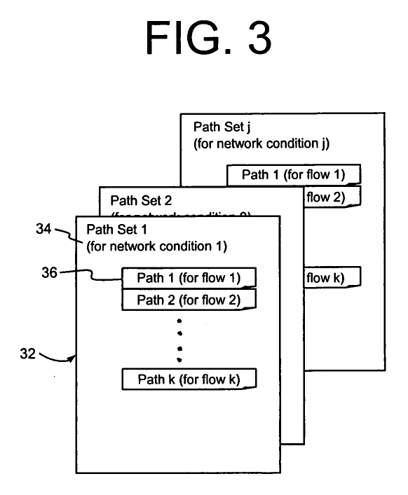

Referring to FIG. 2, an improved method is described for path switching in a multicast distribution environment. A plurality of predetermined path sets are maintained 22 at each of the network routing devices in the distribution environment. Each path set 32 corresponds to a given network condition 34 and defines a path 36 for each data transmission session (also referred to herein as a flow) as shown in FIG. 3. In an exemplary embodiment, a unique identifier is assigned to each network condition and path sets are indexed using the unique identifier. Path data embodied in a single path set may be formulated as a routing table as is known in the art. The path sets are preferably stored in a data store associated with a given network routing device.

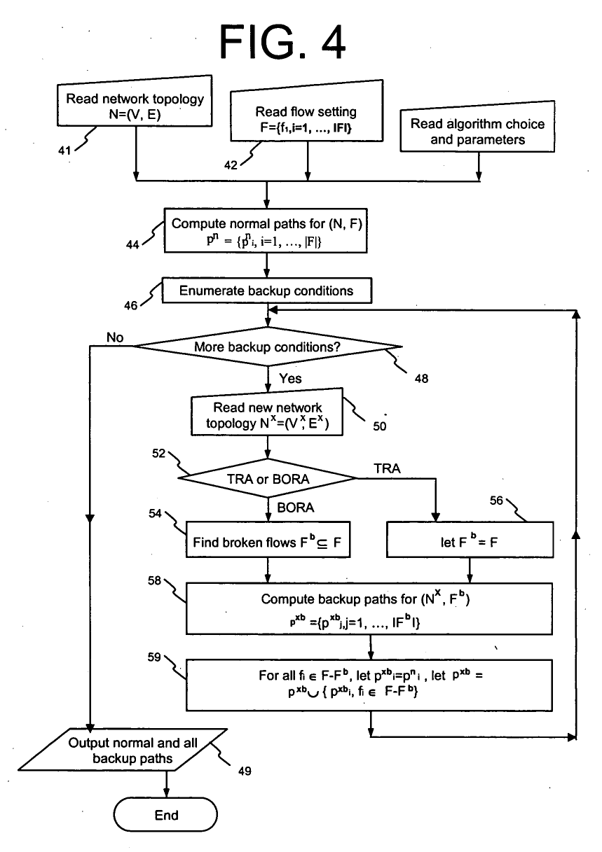

Whenever a multicast distribution environment is setup or a change occurs, path sets are computed by a path computing subsystem of the path management server. In FIG. 4, an exemplary procedure for computing such path sets is set forth. Inputs to the procedure include a network topology 41 as well as a list of data transmission sessions 42. Network topology can be represented as a graph N=(V, E), where V is a set of nodes and E is the set of links connecting these nodes.

Given the network topology and a list of data transmission sessions, paths for each data transmission are computed at step 44. Exemplary algorithms that are particularly suited for computing paths in a multicast environment are further described in U.S. patent application Ser. No. 10/455,833 entitled “Static Dense Multicast Path and Bandwidth Management” which is assigned to present assignee and incorporated by reference herein. However, it is readily understood that other well known algorithms are also within the scope of the present invention. Thus, this step results in a first set of paths corresponding to a normal network operating condition.

Different network operating conditions are then enumerated at step 46. For example, failure of a particular node or a particular link in the network defines a network condition which varies from the normal network operating condition. Thus, a plurality of network conditions can be enumerated by defining a different network condition for each failed node or combinations of failed nodes, each failed link or combinations of failed links, or combinations of failed nodes and failed links. Depending on memory constraints at the network routing devices as well as other system performance criteria, the enumerated network conditions may be an exhaustive list or a subset thereof (e.g., most common conditions). Techniques for enumerating different network conditions are readily known. It is also envisioned that network conditions can be defined for other variations in network operating conditions.

A path set is computed for each enumerated network condition. For a given network condition, the network topology is first modified (if applicable) at step 50. Paths for each data transmission session are then computed at step 58 using a path determining algorithm as described above. This process is repeated for each enumerated network condition as indicated at step 48, thereby yielding a plurality of predetermined path sets.

Paths may be computed using one of two preferred user specified techniques. In one approach, paths for a session are only recomputed if it is adversely affected by the given network condition. Sessions which are adversely affected are identified in step 54. For example, if a path for the session includes a failed link, then the paths for this session are recomputed. If a session is unaffected by the given network condition, then its paths remain as defined for the normal network operating condition. Although this approach is computationally efficient, resulting paths may decrease overall network performance.

In an alternative approach, paths for each session are recomputed for every different network condition as indicated at 56. When paths are computed with an algorithm that accounts for overall network performance, this approach will likely lead to better overall network performance.

Returning to FIG. 2, only one path set is active at any given time on a network routing device. When a data packet arrives, a router looks up the currently active path set. Arriving data packets are then forwarded according to the routing information in the currently active path set.

In an exemplary embodiment, network routing devices as well as other network devices are operable to detect changes 24 in network operating conditions. In a centralized approach, a message indicative of the change in network conditions is sent to a central route manager. At the central route manager, the change in network conditions is correlated at 26 to one of the plurality of predefined network conditions. A message indicative of the current network condition is then transmitted by the central route manager to each of the network routing devices.

Upon receiving this message, the network routing device activates the path set which corresponds to the current network condition as indicated at 28. To activate a path set, each network routing device maintains an indicator for the current network condition. This indicator is updated with the current network condition as reported by the central route manager and then used to access the applicable path set. Subsequently arriving data packets are then forwarded according to the routing information in this activated path set. Because routing information is not re-computed upon the occurrence of a network failure nor are routing messages being exchanged amongst each of the routers, this design achieves a fast path switching mechanism.

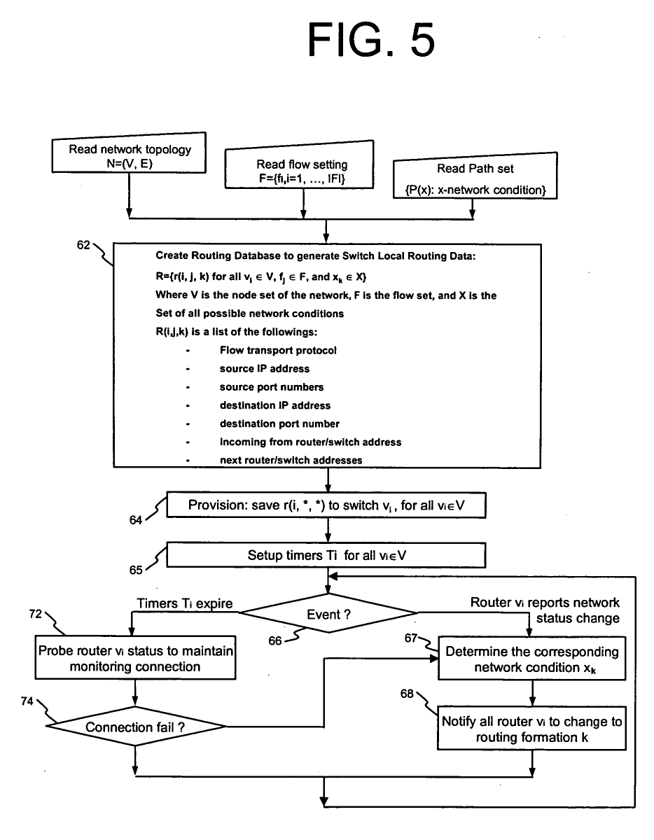

FIG. 5 illustrates an exemplary implementation of the central route managing subsystem. In general, the route managing subsystem cooperatively operates with the path computing subsystem to provision the network routing devices. For instance, the plurality of predetermined path sets from the path computing subsystem serves as an input to the route managing subsystem. It is envisioned that the route managing subsystem may reside on the path management server or another computing device associated with the network environment.

In operation, the route managing subsystem generates local switch data for each routing device as indicated at 62. Local switch data is understood to be path data for each possible network condition which is applicable to a given network routing device (i.e., node) and is extracted from the input from the path computing subsystem. Exemplary local switch data may include but is not limited to a flow transport protocol, a source IP address, a source port number, a destination IP address, a destination port number, an incoming router address and a next router address.

Local switch data is then used to provision an applicable network routing device as indicated at 64. Specifically, the local switch data is sent by route managing subsystem to the applicable network routing device. The network routing device in turn stores its local switch data and activates the path set for the current network condition.

Following initial provisioning, the route managing subsystem monitors network conditions and facilitates path switching as described above. To do so, a communication channel is maintained with each network routing device. A timer for each routing device is initiated to periodically check the channel as indicated at 65. The route managing subsystem then enters a polling loop.

When a change is network conditions occurs, the route managing subsystem receives a corresponding event message. The route managing subsystem correlates the network change to one of the predefined network conditions at 67 and then notifies each of the routing devices of the change at 68. In this way, network routing devices are provisioned according to the current network condition. If a predefined network condition was not enumerated to the current network conditions, the route managing subsystem may interface with the path computing subsystem to determine a path set for the current network condition.

When a timer expires, the route managing subsystem probes the communication channel at 72 with the applicable network routing device. For instance, the route managing subsystem may exchange messages with the routing device. If the exchange fails, the routing device is considered down and corrective action may be taken. In particular, the route managing subsystem identifies the network condition at 67 that correlates to the failure of this particular routing device and then notifies all of the other routing devices of the current network condition at 68.

A distributed switching model is also contemplated. In the distributed approach, a change in network conditions is broadcast by the detecting network device to all of the network routing devices. Each network routing device then determine the applicable network condition and reconfigured itself to use the proper path set. The change in network conditions may also be transmitted to the central route manager which will in turn ensure that path switching has been synchronized at all of the network routing devices.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for switching paths at a network routing device residing in a multicast distribution environment, comprising:
maintaining a plurality of predetermined path sets in a data store associated with the network routing device, where each path set corresponds to a given network condition and defines a path for each data transmission session;
receiving a message indicative of a current network condition at the network routing device;
selecting a path set from the plurality of predetermined path sets, where the selected path set correlates to the current network condition; and
routing network traffic at the network routing device in accordance with the selected path set.

2. The method of claim 1 further comprises:
detecting a change in network conditions;
correlating the change in network conditions to one of a plurality of predefined network conditions, thereby identifying the current network condition; and
sending a message indicative of the current network condition to the network routing device.

3. The method of claim 2 wherein the step of detecting a change further comprises detecting a failed node or a failed link in the network environment.

4. The method of claim 2 wherein the step of detecting a change in network conditions further comprises detecting the change at one of the network routing devices in the distribution environment, and sending a message indicative of the change in network conditions to a central route manager.

5. The method of claim 4 further comprises sending a message indicative of the current network condition to each of the network routing devices residing in the distribution environment.

6. The method of claim 1 further comprises
identifying a plurality of data transmission sessions supported by the multicast distribution environment;
determining a path for each data transmission session, where the path is based on the network environment having a normal operating condition;
identifying at least one network failure condition which varies from the normal operating condition; and
determining a path for each data transmission based on the identified network condition, thereby defining the plurality of predetermined path sets.

7. The method of claim 6 wherein the step of determining a path further comprises re-computing paths only for data transmission sessions which are adversely affected by the network failure condition and maintaining paths for data transmission sessions which are not affected by the network failure condition.

8. The method of claim 6 wherein the step of determining a path further comprises re-computing a path for each data transmission session.

9. A method for provisioning network routing devices residing in a multicast distribution environment, comprising:
identifying a plurality of data transmission sessions supported by the multicast distribution environment;
determining a path for each data transmission session, where the path is based on the network environment having a normal operating condition;
enumerating a plurality of different network failure conditions which vary from the normal operating condition;
determining a path for each data transmission session for each of the plurality of network failure conditions, thereby defining the plurality of predetermined path sets; and
provisioning at least one network routing device with the plurality of predetermined path sets.

10. A multicast management system comprising:
a plurality of network routing devices residing in a multicast distribution environment, each of the network routing devices maintains a plurality of predetermined path sets, where each path set corresponds to a given network operating condition and defines a path for each data transmission session supported in the distribution environment; and
a route managing subsystem in data communication with the plurality of network routing devices and operable to notify the network routing devices regarding a current network operating conditions, wherein the network routing devices selects a path set from the plurality of predetermined path sets which correlates to the current network operating condition and routes network traffic in accordance with the selected path set.

11. The multicast management system of claim 10 wherein the route managing subsystem is adapted to receive notification of a change in network operating conditions and operable to communicate the current network operating conditions to the plurality of network routing devices.

12. The multicast management system of claim 11 wherein one of the network routing devices detects the change in network operating conditions and communicates the change in network operating conditions to the route managing subsystem.

13. The multicast management system of claim 10 wherein the route managing subsystem is operable to periodically probes each of the network routing devices and determines an applicable network operating condition when a given network routing devices fails to respond to its probe.

14. The multicast management system of claim 10 further comprises a path computing subsystem in data communication with the route managing subsystem and operable to compute a path for each data transmission session supported in the distribution environment.

15. The multicast management system of claim 10 wherein the route managing subsystem is operable to provision the plurality of network routing devices with the plurality of predetermined path sets.
